(19) United States
(12) Patent Application Publication
(10) Pub. No.: US 2014/0063404 A1
(43) Pub. Date: Mar. 6, 2014

(54) LCD MODULE AND LCD DEVICE

(71) Applicant: Shenzhen China Star Optoelectronics Technology Co.Ltd., Shenzhen (CN)

(72) Inventors: Shihhsiang CHEN, Shenzhen (CN); Gang YU, Shenzhen (CN)

(21) Appl. No.: 13/643,086

(22) PCT Filed: Sep. 27, 2012
(86) PCT No.: PCT/CN2012/082109

§ 371 Date: Oct. 24, 2012

(30) Foreign Application Priority Data
Aug. 31, 2012 (CN) 201220442211.7

(51) Int. Cl. G02F 1/1333

(52) U.S. Cl. CPC G02F 1/133308
USPC 349/58

(57) ABSTRACT

A liquid crystal display (LCD) module includes a backplane, a light source support and a frame arranged on the backplane. The edge of the backplane arranged on the light source support is not configured with a sidewall. The frame is configured with at least one connecting strip. The connecting strip and the light source support are mutually fixed through a pair of clamping stucture and groove which are mutually engaged. The clamping stucture and the groove are arranged on the connecting strip and the light source support, respectively. The clamping stucture and the groove are further arranged on the light source support and the connecting strip, respectively.

### TECHNICAL FIELD

The present disclosure relates to the field of liquid crystal displays (LCDs), and more particularly to an LCD module and an LCD device.

### BACKGROUND

A liquid crystal display (LCD) module is one key component of an LCD device and is mainly used to provide adequate luminance, uniformly distributed light source, and display images.

FIG. 1 and FIG. 2 show an LCD module of an LCD device, including a backplane 100, a lightbar 140 fixed to a sidewall 101 of the backplane 100, a reflector 110 arranged on the backplane 100, a light guide panel 120 arranged on the reflector 110, a middle frame 200a and a front frame 200b that are arranged outside the backplane 100 and press against the light guide panel 120. An optical diaphragm 130 is arranged on a light emitting surface of the light guide panel 120, and an LCD panel 300 is fixed on a backlight module by components including the middle frame 200a and the front frame 200b.

As shown in FIG. 2, the sidewall 101 is arranged on an edge of the backplane 100. The middle frame 200a and the front frame 200b are fixed to the sidewall 101 of the backplane 100 through screws. Screw holes are arranged on the sidewall 101 of the backplane 100. The lightbar 140 is configured with a light source support 145. The lightbar 140 is fixed to the sidewall 101 of the backplane 100 through the light source support 145. Due to existence of the light source support 145, it is difficult for the LCD device have a narrow frame design and does not increase optical coupling distance.

### SUMMARY

In view of the above-described problems, the aim of the present disclosure is to provide a liquid crystal display (LCD) module and an LCD device with narrower frame and convenient installation.

The purpose of the present disclosure is achieved by the following technical scheme: An LCD module comprising a backplane, a light source support arranged on at least one edge of the backplane, and a middle frame arranged on the backplane and fixed relative to the backplane. The edge of the backplane arranged on the light source support is not configured with a sidewalk. The middle frame is configured with at least one connecting strip. The connecting strip and the light source support are mutually fixed through a pair of lug head and groove which are mutually engaged. The lug head and the groove are arranged on the connecting strip and the light source support, respectively. A clamping stucture and the groove are further arranged on the light source support and the connecting strip respectively.

The purpose of the present disclosure can also be achieved by the following technical scheme: An LCD module comprising a backplane, a light source support arranged on at least one edge of the backplane, and a frame arranged on the backplane. The edge of the backplane arranged on the light source support is not configured with the sidewall. The frame is configured with at least one connecting strip. The connecting strip and the light source support are mutually fixed through a pair of clamping stucture and groove which are mutually engaged. The clamping stucture and the groove are arranged on the connecting strip and the light source support, respectively. The clamping stucture and the groove are further arranged on the light source support and the connecting strip, respectively.

In one example, the frame is a middle frame.

In one example, the clamping stucture is a lug head arranged on the light source support. The groove is arranged on the connecting strip. The lug head and the groove are engaged.

In one example, the clamping stucture is a barb arranged at an end of the connecting strip. The groove is arranged on the light source support. The barb is engaged with the groove.

In one example, sidewalls are arranged on the edge of the backplane where the light source support is not arranged. The middle frame is configured with at least one connecting strip. The connecting strip and the backplane are mutually fixed through a pair of clamping stucture and groove which are mutually engaged. The clamping stucture and the groove are arranged on the connecting stop and the sidewall of the backplane, respectively. The clamping stucture and the groove are further arranged on the sidewall of the backplane and the connecting strip, respectively. By arranging the clamping stucture and the groove on the sidewall of the backplane, the middle frame can be directly pressed against so as to engage the groove and the clamping stucture, thus finishing the assembly of the middle frame. Thus, the middle frame is installed, without s screws, and assembly material and assembly time are saved.

In one example, the frame is a front frame. In some designs of not arranging the middle frame of the LCD module, or if the middle frame is not fixed to the light source support but is connected to the sidewall on the edge of the backplane where the light source support is not arranged, the front frame may also be directly fixed to the light source support.

In one example, the clamping stucture is a lug head arranged on the light source support. The groove is arranged on the connecting strip. The lug head and the groove are engaged.

In one example, the clamping stucture is a barb arranged at the end of the connecting strip. The groove is arranged on the light source support. The barb is engaged with the groove.

In one example, the sidewall is arranged on the edge of the backplane where the light source support is not arranged. The middle frame is configured with at least one connecting strip. The connecting strip and the backplane are mutually fixed through a pair of clamping stucture and groove which are mutually engaged. The clamping stucture and the groove are arranged on the connecting strip and the sidewall of the backplane, respectively. The clamping stucture and the groove are respectively arranged on the sidewall of the backplane and the connecting strip, respectively. By arranging the clamping stucture and the groove on the sidewall of the backplane, the middle frame can be directly pressed against so as to engage the groove and the clamping stucture, thus finishing the assembly of the middle frame. Thus, the middle frame is installed without screws, and assembly material and assembly time are saved.

An LCD device comprises an LCD module mentioned above.

In the present disclosure, because the edge of the backplane arranged on the light source support is not configured with a sidewall and at least one pair of clamping stucture and groove which are mutually engaged are arranged between the frame and the light source support, the light source support moves out. That is, the frame of the LCD module is shortened by thickness of one sidewall of the backplane. The LCD module can have a narrow frame design. Moreover, the frame is convenient to be installed to the light source support. The frame is only pressed down without need of complicated screw installation, which improves installation efficiency of the LCD module.

### BRIEF DESCRIPTION OF FIGURES

FIG. 1 is a structural diagram of a typical liquid crystal display (LCD) nodule;

FIG. 2 is a sectional simplified structural diagram of a typical LCD module;

FIG. 3 is a structural diagram of an LCD module of an example of the present disclosure;

FIG. 4A and FIG. 4B are structural change diagrams of a backplane and a light source support of an example of the present disclosure;

FIG. 5 is a sectional simplified structural diagram of an LCD module of a first example of the present disclosure:

FIG. 6 is a schematic diagram of a fixed mode of as middle frame or a front frame and a light source support of a first example of the present disclosure;

FIG. 7 is a simplified structural diagram of a middle frame and a light source support of a first example of the present disclosure;

FIG. 8 is a simplified structural diagram of a middle frame a front frame and a light source support of a second example of the present disclosure;

FIG. 9 is a simplified structural diagram of a middle frame being improved in a first example or a second example of the present disclosure;

FIG. 10 is a simplified structural diagram of a backplane being improved in a first example or a second example of the present disclosure.

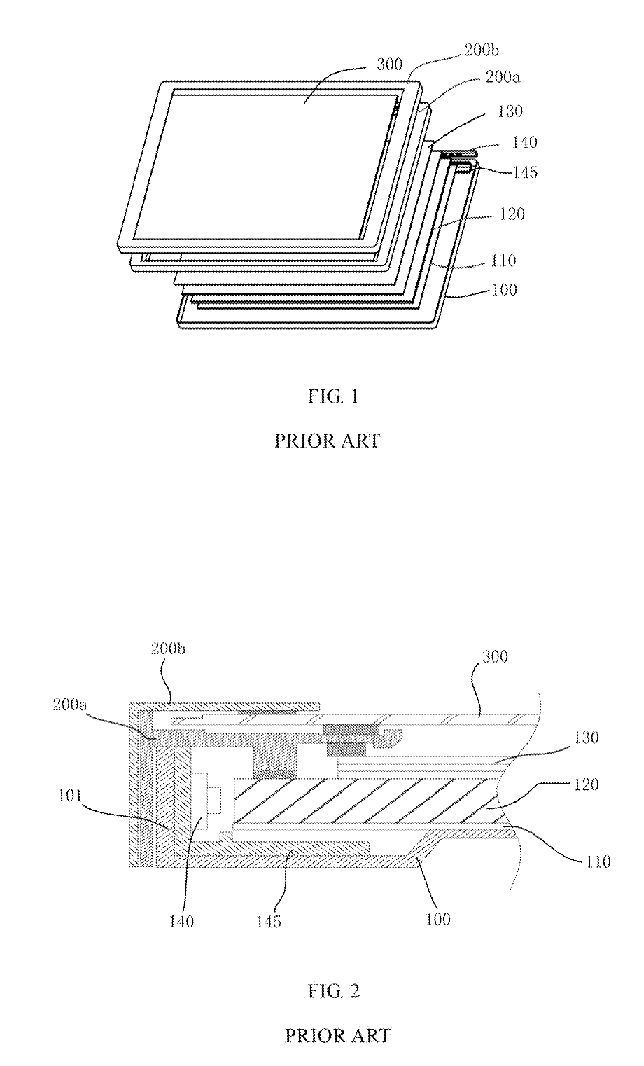

Legends: 100. backplane; 101. sidewall; 110. reflector; 120. light guide panel; 130. optical diaphragm; 140. lightbar; 145. light source support; 210. connecting strip; 200. frame; 200a. middle frame; 200b. front frame: 300. LCD panel; 3(3a,3b). groove, 7. clamping stucture (7a. lug head: 7b, barb).

### DETAILED DESCRIPTION

The present disclosure will further be described in detail in accordance with the figures and the embodiments.

### EXAMPLE 1

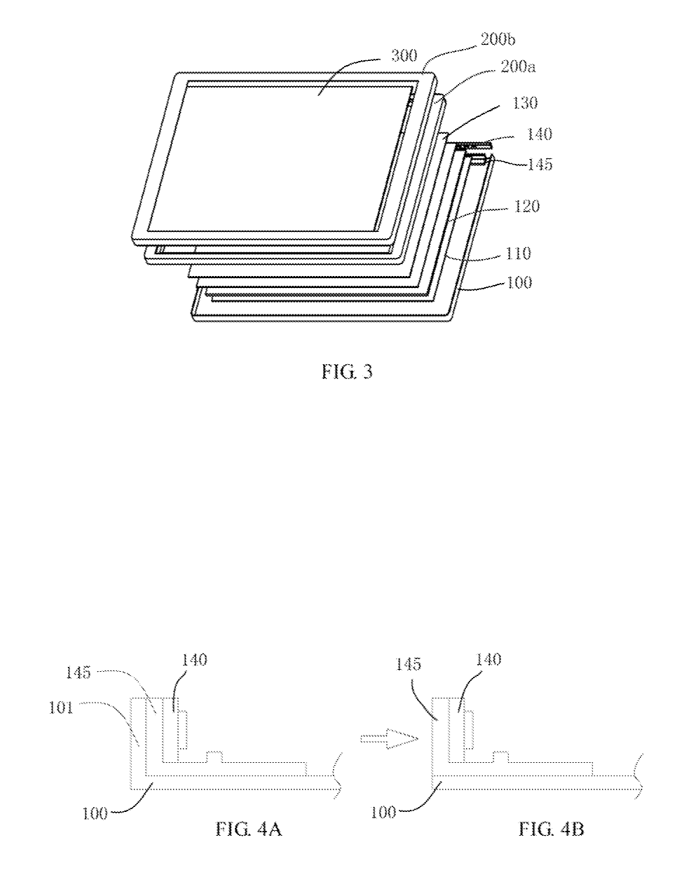

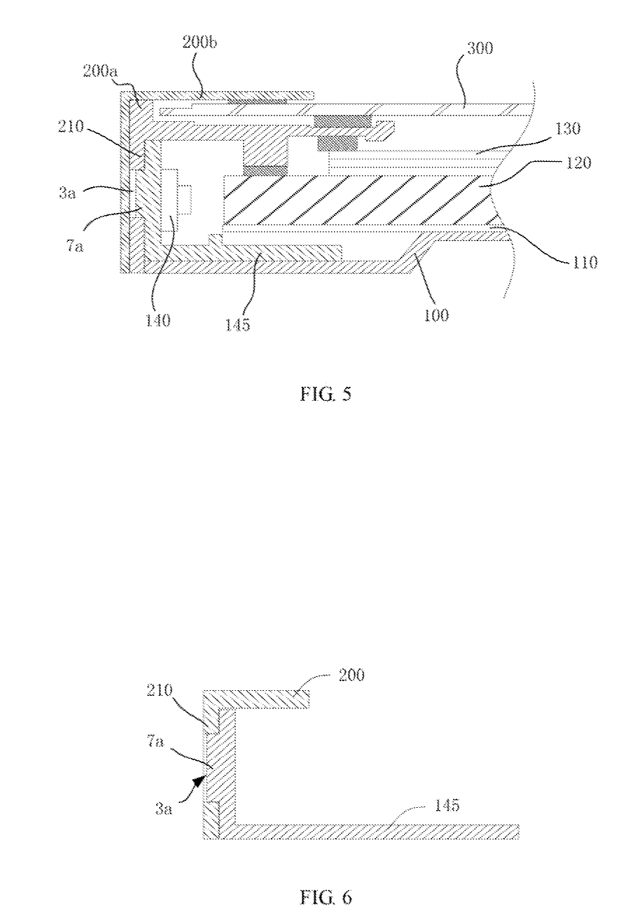

FIG. 3 and FIG. 5 show an exemplary example of a liquid crystal display (LCD) module of the present disclosure. The LCD module comprises a backplane 100, a lightbar 140 arranged at one edge of the backplane 100, a reflector 110 arranged on the backplane 100, a light guide panel 120 arranged on the reflector 110, and a frame 200 (middle frame 200a or front frame 200b) arranged on the backplane 100. An optical diaphragm 130 is arranged on a light emergence surface of the light guide panel 120. The LCD panel 300 is fixed above a backlight module by components including the middle frame 200a and the front frame 200b. As shown in FIG. 4B, the lightbar 140 of the example is configured with a light source support 145. The lightbar 140 is fixed to the edge of the backplane 100 through the light source support 145. The edge of the backplane 100 arranged on the light source support 145 is not configured with a sidewall 101, as shown in FIG. 4A. In this way, the light source support 145 moves outwards. That is, the frame of the LCD module is shortened by thickness of one sidewall of the backplane. Thus, the LCD module can have a narrow frame design Meanwhile, the optical coupling distance between the light guide panel 120 and the lightbar 140 is increased, thus improving display effects.

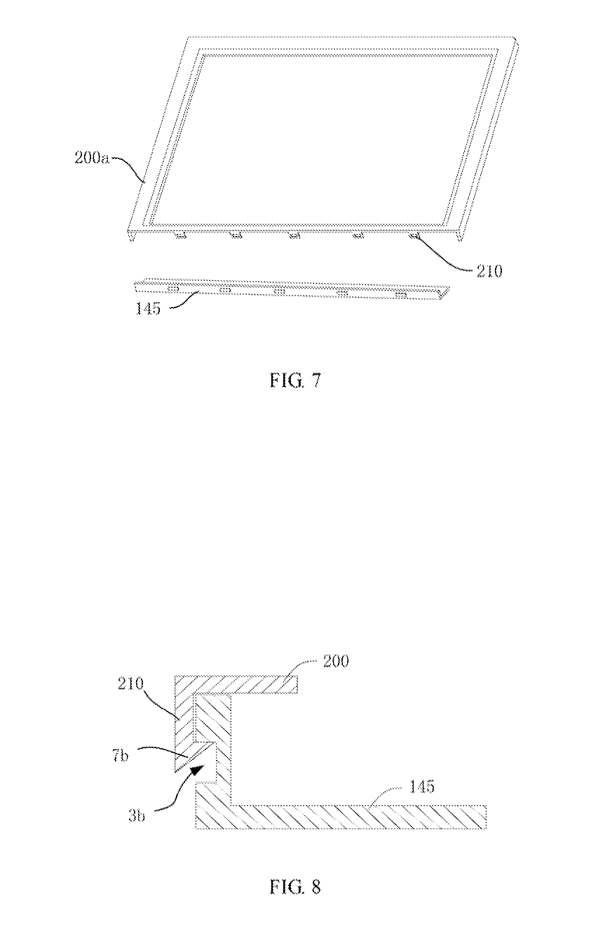

Because the edge of the backplane 100 arranged on the light source support 145 is not configured with the sidewall, the fixation of the middle frame 200a or the front frame 200b needs to be redesigned. As shown in FIG. 5 to FIG. 7, taking the middle frame 200a as an example, the light source support 145 is configured with a clamping stucture 7. The clamping stucture 7 is a lug head 7a arranged on the side surface of the light source support 145 opposite to one side of the light source. The middle frame 200a is configured with a connecting strip 210. The connecting strip 210 is configured with a groove 3a. The groove 3a and the lug head 7a may be mutually engaged. In this way, the light source support 145 and the middle frame 200a may be mutually fixed. The middle frame 200a is convenient to install by using the fixed mode of the structure. The middle frame 200a is only pressed down without need of complicated screw installation, which improves installation efficiency of the LCD module.

### EXAMPLE 2

As shown in FIG. 8, difference between the example 2 and the example 1 is that the clamping stucture 7 is a barb 7b arranged on the connecting strip 210, the light source support 145 is configured with a groove 3b, and the groove 3b and the barb 7b are mutually engaged to mutually fix the middle frame 200a and the light source support 145.

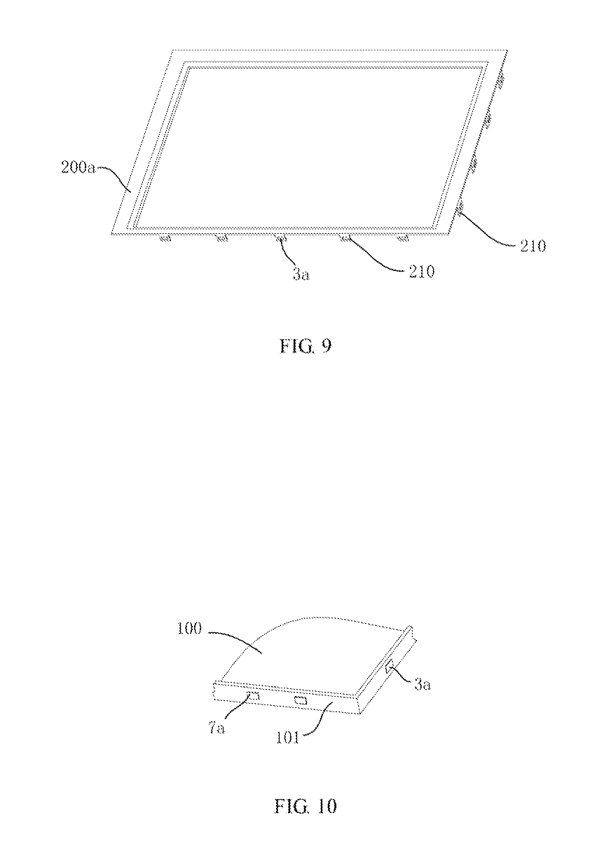

For the two examples above, another improvement may be carried out. As shown in FIG. 9 and FIG. 10, sidewalls 101 are arranged on the edge of the backplane 100 where the light source support is not arranged. A clamping stucture 7 is arranged on the sidewall 101. The middle frame 200a is configured with a groove 3 matched with the clamping stucture 7. The clamping stucture 7 is engaged with the groove 3. By arranging the clamping stucture 7 and the groove 3 on the sidewall 101 of the backplane 100, the middle frame 200a may be directly pressed down so as to engage the groove 3 and the clamping stucture 7, thus completing assembly of the middle frame 200a. Thus, the middle frame 200a is installed without screws, and assembly material and assembly time are saved.

The present disclosure is described in accordance with the example with fixation between the middle frame 200a and the light source support 145. The frame 200 mentioned in the present disclosure further comprises a front frame 200b. In the case of some segmented middle frames (only L-shaped middle frames supporting the LCD panel are arranged at four corners of the LCD module), or the LCD module without the middle frame in some designs, the front frame 200b may be fixed with the light source support 145 or the backplane 100 by using the fixed mode shown in FIG. 6.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A liquid crystal display (LCD) module, comprising:
a backplane;
a light source support arranged on at least one edge of the backplane; and
a middle frame arranged on the backplane and fixed relative to the backplane;
wherein the edge of the backplane arranged on the light source support is not configured with a sidewall; the middle frame is configured with at least one connecting strip; the connecting strip and the light source support are mutually fixed through a pair of mutually engaged lug head and groove; the lug head and the groove are arranged on the connecting strip and the light source support, respectively; a clamping stucture and the groove are further arranged on the light source support and the connecting strip, respectively.

2. A liquid crystal display (LCD) module, comprising:
a backplane;
a light source support arranged on at least one edge of the backplane; and
a frame arranged on the backplane;
wherein the edge of the backplane arranged on the light source support is not configured with a sidewall;
wherein the frame is configured with at least one connecting strip; the connecting strip and the light source support are mutually fixed through a pair of mutually engaged clamping structure and groove; the clamping structure and the groove are arranged on the connecting strip and the light source support, respectively; the clamping structure and the groove are further arranged on the light source support and the connecting strip, respectively.

3. The liquid crystal display (LCD) module of claim 2, wherein the frame is a middle frame.

4. The liquid crystal display (LCD) module of claim 3, wherein the clamping structure is a lug head arranged on the light source support; the groove is arranged on the connecting strip; the lug head and the groove are engaged.

5. The liquid crystal display (LCD) module of claim 3, wherein the clamping strcuture is a barb arranged at an end of the connecting strip, the groove is arranged On the light source support; the barb is engaged with the groove.

6. The liquid crystal display (LCD) module of claim 3, wherein sidewalls are arranged on the edge of the backplane where the light source support is not arranged; the middle frame is configured with at least one connecting strip; the connecting strip and the backplane are mutually fixed through a pair of mutually engaged clamping sturcutre and groove; the clamping sturcutre and the groove are arranged on the connecting strip and the sidewall of the backplane, respectively; the clamping sturcture and the groove are arranged on the sidewall of the backplane and the connecting strip, respectively.

7. The liquid crystal display (LCD) module of claim 2, wherein the frame is a front frame.

8. The liquid crystal display (LCD) module of claim 7, wherein the clamping sturcutre is a lug head arranged on the light source support; the groove is arranged on the connecting strip; the lug head and the groove are engaged.

9. The liquid crystal display (LCD) module of claim 7, wherein the clamping sturcture is a barb arranged at an end of the connecting strip; the groove is arranged on the light source support; the barb is engaged with the groove.

10. The liquid crystal display (LCD) module of claim 7, wherein sidewalls are arranged on the edge of the backplane were the light source support is not arranged; the front frame is configured with at least one connecting strip; the connecting strip and the backplane are mutually fixed through a pair of mutually engaged clamping part and groove; the clamping sturcutre and the groove are arranged on the connecting strip and the sidewall of the backplane, respectively; the clamping sturctre and the groove are arranged on the sidewall of the backplane and the connecting strip, respectively.

11. A liquid crystal display (LCD) device, comprising:
a backplane;
a light source support arranged on at least one edge of the backplane; and
a frame arranged on the backplane;
wherein the edge of the backplane arranged on the light source support is not configured with a sidewall;
wherein the frame is configured with at least one connecting strip; the connecting strip and the light source support are mutually fixed through a pair of mutually engaged clamping part and groove; the clamping stucture and the groove are arranged on the connecting strip and the light source support, respectively; the clamping stucture and the groove are further arranged on the light source support and the connecting strip, respectively.

12. The liquid crystal display (LCD) device of claim 11, wherein the frame is a middle frame.

13. The liquid crystal display (LCD) device of claim 12, wherein the clamping stucture is a lug head arranged on the light source support; the groove is arranged on the connecting strip; wherein the lug head and the groove are engaged.

14. The liquid crystal display (LCD) device of claim 12, wherein the clamping stucture is a barb arranged at an end of the connecting strip; the groove is arranged On the light source support; wherein the barb is engaged with the groove.

15. The liquid crystal display (LCD) device of claim 12, wherein the sidewall is arranged on the edge of the backplane where the light source support is not arranged; the middle frame is configured with at least one connecting strip; wherein the connecting strip and the backplane are mutually fixed through a pair of mutually engaged clamping stucture and groove; the clamping stucture and the groove are arranged on the connecting strip and the sidewall of the backplane, respectively; the clamping stucture and the groove are further arranged on the sidewall of the backplane and the connecting strip, respectively.

16. The liquid crystal display (LCD) device of claim 11, wherein the frame is a front frame.

17. The liquid crystal display (LCD) device of claim 16, wherein the clamping stucture is a lug head arranged on the light source support; the groove is arranged on the connecting strip; the lug head and the groove are engaged.

18. liquid crystal display (LCD) device of claim 16 wherein the clamping stucture is a barb arranged at an end of the connecting strip; the groove is arranged on the light source support; he barb is engaged with the groove.

19. liquid crystal display (LCD) device of claim 16, wherein the sidewall is arranged on the edge of the backplane where the light source support is not arranged; the front frame is configured with at least one connecting strip; the connecting strip and the backplane are mutually fixed through a pair of mutually engaged clamping stucture and groove; the clamping stucture and the groove are arranged on the connecting strip and the sidewall of the backplane, respectively; optionally, the clamping stucture and the groove are further arranged on the sidewall of the backplane and the connecting strip, respectively.
